(19) United States
(12) Patent Application Publication
(10) Pub. No.: US 2011/0173270 A1
(43) Pub. Date: Jul. 14, 2011

(54) Conferencing Apparatus And Method

(75) Inventors: Yuki Uchida, West Caldwell, NJ (US); Shun Tanaka, West Caldwell, NJ (US)

(73) Assignee: RICOH COMPANY, LTD., Tokyo (JP)

(21) Appl. No.: 12/685,508

(22) Filed: Jan. 11, 2010

(51) Int. Cl. G06F 3/01; G06F 15/16; G06F 17/30

(52) U.S. Cl. 709/206; 715/753; 707/802; 707/E17.044

(57) ABSTRACT

Apparatuses, systems and methods are provided for processing data in an online conference and, in particular, for generating a desktop recording of desktop image data shared in an online conference.

### TECHNICAL FIELD

This disclosure relates to the processing of data in an online conference, and more particularly, systems, apparatuses and methodologies for generating a desktop recording of desktop image data shared in an online conference.

### BACKGROUND

In the current information age, information technology (IT) tools for online conferencing and collaborative computing have become extensively used in enterprises, other organizations, and even home environments to communicate electronic documents and data through a network. Online conferences can allow traditional face-to-face meetings to take place virtually over great distances through computer or telecommunicative networks, with the use of electronic communication technologies.

In a typical online conference, a user commonly referred to as a “presenter” or “leader” shares various forms of electronic information with a plurality of viewing users, commonly referred to as “attendees” or “participants”. For example, a video camera and microphone coupled to the presenter's computer may capture and transmit video and audio information to a designated computer, and vice versa.

A specialized variant of online conferencing is desktop sharing, which involves the sharing of data from a computer desktop of one terminal with another terminal. For example, image data of a document or presentation that is displayed on the presenter's computer desktop screen can be transmitted via a computer network connection to the attendee's computers. Moreover, image data produced by an application that is executing on the presenter's computer, which is likewise displayed on the presenter's computer desktop screen, can be transmitted via a computer network connection to the attendee's computers. Thus, the attendees of the meeting see the “shared” desktop image data on their own computer desktop screens, and are able to see the same image displayed on the presenter's computer display. Such features of desktop sharing allow a presenter to share a document or presentation with an attendee, and also allow a presenter to demonstrate to an attendee how to use a particular application or how to perform an operation.

Like the need to take notes and/or retain handouts in conventional face-to-face meetings, there is often a need to record the online conference and the information shared in the online conference, such as desktop image data shared in an online conference.

However, functionalities in current online conferencing systems to record shared desktop image data have several drawbacks.

For example, current recording techniques require a user (such as the presenter in the online conference) to take deliberate and affirmative steps to invoke the recording of the conference, by manually selecting an application button, such as “Start”, “Record” or “Start Recording”. Similarly, when the conference has completed, a user must take affirmative steps to terminate the recording of the conference (by selecting a “Stop” or “Stop Recording” application button, for example). Such requirements cause great inconvenience, are time-consuming and tedious and may even prove to be a difficult obstacle, depending on the complexity of the particular conferencing software used. For example, a user may inadvertently start a desktop recording too early/late, or may stop the desktop recording too early/late, or may forget to record the online conference entirely.

Further, in current systems the desktop recordings are typically stored at a location automatically selected by the system. When a user wishes to view the desktop recording at a later time, the user must access the conferencing system or storage device and attempt to locate and determine the correct desktop recording. For similar reasons, it is also difficult for a user to change the content of a desktop recording at a later time. Such an approach for retrieving and changing the desktop recording is complicated and inconvenient to the user.

There exists a need for an improved approach for recording and storing desktop image data shared in an online conference, and an improved approach for retrieving such a stored desktop recording, using techniques that are efficient and not a difficult to use (as a practical matter).

### SUMMARY

This disclosure provides tools (in the form of systems, apparatuses and methodologies) for processing data in an online conference, and more particularly, for generating a desktop recording of desktop image data shared in an online conference.

In an aspect of this disclosure, it is determined when an online conference between a plurality of terminals connected to a network starts, by monitoring data transmitted by the plurality of terminals to the network and determining based on the transmitted data when at least one of the plurality of terminals begins transmitting desktop image data to be shared with the plurality of terminals to the network.

In another aspect of this disclosure, a desktop recording of desktop image data shared between a plurality of terminals in an online conference is automatically initiated, when it is determined that the online conference between a plurality of terminals has started or is ready to start.

In another aspect of this disclosure, it is determined when an online conference between a plurality of terminals connected to a network ends, by monitoring data transmitted by the plurality of terminals to the network and determining based on the transmitted data when at least one of the plurality of terminals stops transmitting desktop image data to be shared with the plurality of terminals to the network.

In another aspect of this disclosure, a desktop recording of desktop image data shared between a plurality of terminals in an online conference is automatically terminated and transmitted to a data repository, when it is determined that the online conference has ended.

In another aspect of this disclosure, a report email is prepared and transmitted to a plurality of terminals in an online conference, the report email including acquisition information for acquiring from a data repository a desktop recording of desktop image data shared between the plurality of terminals in the online conference.

In another aspect of this disclosure, it is determined whether an update command with instructions to update a desktop recording is required, based on user input, and when it is determined that the update command is required, the update command is generated and transmitted to a conferencing apparatus.

### BRIEF DESCRIPTION OF THE DRAWINGS

The above-mentioned and other features, aspects and advantages can be more readily understood from the following detailed description with reference to the accompanying drawings wherein:

FIG. 1 shows a block diagram of a system, according to an exemplary embodiment of this disclosure;

FIG. 2 shows a block diagram of a system, according to another exemplary embodiment of this disclosure;

FIG. 3 shows a block diagram of a system, according to another exemplary embodiment of this disclosure;

FIG. 4 shows a block diagram of an exemplary configuration of a conferencing apparatus;

FIG. 5 shows a block diagram of an exemplary configuration of a terminal apparatus;

FIG. 6 shows an example of conference participation information;

FIG. 7 shows an example of storage contents of a data repository;

FIG. 8 shows a flow chart illustrating an example of a workflow on a conferencing apparatus side, in an exemplary embodiment;

FIG. 9 shows a flow chart illustrating a more detailed example of a workflow on a conferencing apparatus side;

FIGS. 10A and 10B show a flow chart illustrating a more detailed example of a workflow on a conferencing apparatus side;

FIG. 11 shows a flow chart illustrating an example of a workflow on a terminal apparatus side, in another exemplary embodiment;

FIG. 12 shows a flow chart illustrating a more detailed example of a workflow on a terminal apparatus side;

FIG. 13 shows a schematic view of an example of data flow in an exemplary embodiment.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

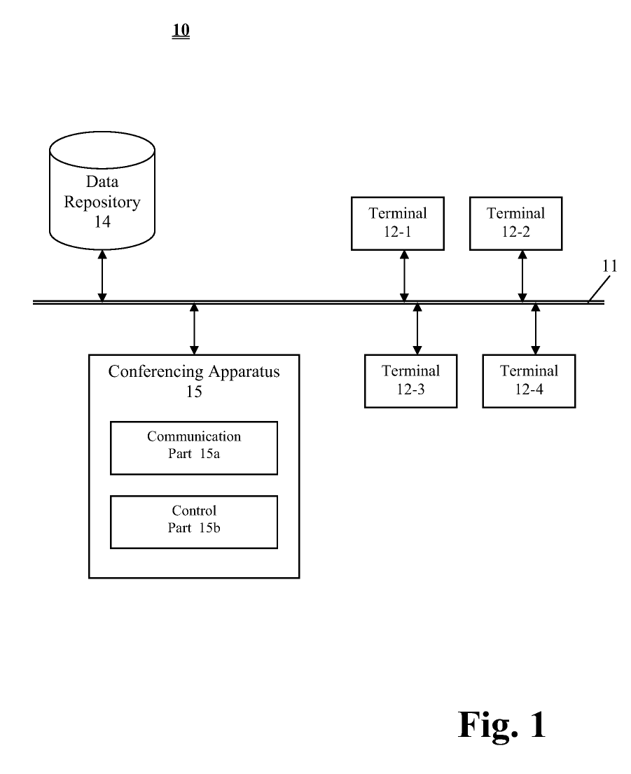

Referring now to the drawings, wherein like reference numerals designate identical or corresponding parts throughout the several views, FIG. 1 shows schematically a conferencing system for generating a desktop recording of desktop image data shared in an online conference, according to an exemplary embodiment of this disclosure.

System 10 includes a data repository 14, a conferencing apparatus 15, and a plurality of terminals 12-1 through 12-4, all of which are interconnected by a network 11.

The terminals 12-1 through 12-4 are configured with software allowing the terminals to communicate through the network with each other. In particular, the terminals 12-1 through 12-4 may participate in an online conference with each other, where various files and data (including desktop image data used to output an image to a display part of one of the terminals) are shared between the terminals in the online conference. Thus, a user at one of the terminals 12-1 through 12-4 may share desktop image data with viewing users at the remaining terminals. The terminals 12-1 through 12-4 are also configured to communicate with the data repository 14 and the conferencing apparatus 15, through the network.

Conferencing apparatus 15 includes a communication part 15a, and a control part 15b.

The communication part 15a of the conferencing apparatus 15 is configured to communicate with the data repository 14 which is connected to the conferencing apparatus 15 through the network 11.

The control part 15b of the conferencing apparatus 15 is configured to determine when an online conference between the plurality of terminals 12-1 through 12-4 connected to the network starts. The control part does this by monitoring data transmitted by the plurality of terminals to the network and determining, based on the transmitted data, when at least one of the plurality of terminals 12-1 through 12-4 begins transmitting desktop image data to the network. This is the desktop image data that is to be shared with the plurality of terminals during the online conference. The control part 15b is also configured to automatically initiate a desktop recording of the desktop image data shared between the plurality of terminals 12-1 through 12-4, when it is determined that the online conference has started or is ready to start.

Thus, according to this exemplary embodiment of the present invention, there is provided the tools for the efficient recording of desktop image data shared in an online conference. Whereas the recording techniques of the prior art require a participant in an online conference to manually initiate the recording of shared desktop image data, the conferencing system of the present application smartly determines when an online conference starts, and automatically (without user entry of a command or instruction) initiates the recording of the shared desktop image data at the most appropriate time. Hence, the operational convenience to users of the present invention is greatly increased.

According to another exemplary embodiment, the control part 15b is further configured to determine when an online conference ends. The control part does this by monitoring data transmitted by the plurality of terminals to the network and determining, based on the transmitted data, when at least one of the plurality of terminals 12-1 through 12-4 stops transmitting desktop image data to the network. Moreover, the control part 15b automatically terminates the desktop recording and transmits the desktop recording to the data repository 14, when it is determined that the online conference has ended. The desktop recording may be stored in a temporary storage area/buffer of the conferencing apparatus 15 (not shown), before the desktop recording is transmitted to the data repository 14.

Thus, according to this exemplary embodiment of the present invention, there is provided further tools for the efficient recording of desktop image data shared in an online conference. Whereas the recording techniques of the prior art require a participant in an online conference to manually terminate the recording of shared desktop image data, the conferencing system of the present application smartly determines when an online conference ends, and automatically (without user entry of a command or instruction) terminates and stores the recording of the shared desktop image data at the most appropriate time. Hence, the operational convenience to users of the present invention is greatly increased.

It should be understood the desktop image data includes any image data that may be used to generate an image and display such an image on a display unit of a terminal. Thus, the desktop image data may correspond to any image, document, font, icon, character, menu or presentation that is displayed on a computer desktop device, and is not limited to the sharing of video sequences, moving mouse cursors, applications, etc.

In a preferred embodiment, the conferencing apparatus 15 also functions as a traditional “conference server”, in that the conferencing apparatus 15 hosts the online conference and coordinates the flow of all the information shared between the plurality of terminals 12-1 through 12-4 in the online conference. As is well known in the art, a conference server commences an online conference by accepting a logging on of an authorized attendee computer (by receiving user identification information transmitted by each of the attendee computers, for example). Thereafter, the conference server establishes connections between all of the attendee computers, and routes the desktop image data streams generated by any of the attendee computers among the remaining attendee computers.

Alternatively, it should be understood that conferencing apparatus 15 is not required to function strictly as a traditional conference server connected directly to a network. For example, the conferencing apparatus may be one of a plurality of terminals participating in a peer-to-peer type online conference. Further, the conference apparatus 15 may instead be connected to a dedicated traditional conference server connected to the network.

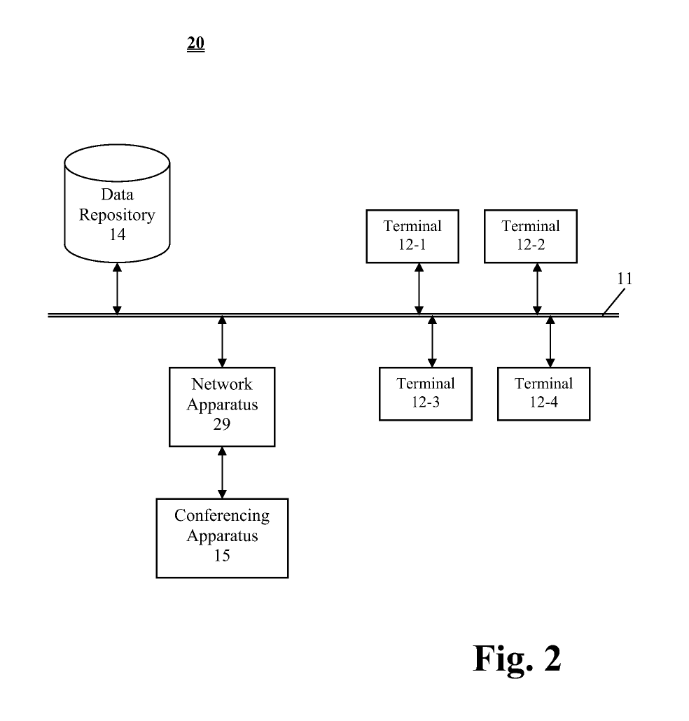

For example, FIG. 2 shows a block diagram of a system, according to another exemplary embodiment of this disclosure. System 20 includes terminals 12-1 through 12-4, data repository 14, conferencing apparatus 15 and network apparatus 29, all of which are interconnected by a network 11. Network 11, terminals 12-1 through 12-4, data repository 14, and network apparatus 15 are substantially similar to those depicted in FIG. 1. Thus, system 20 depicted in FIG. 2 is the same as system 10 depicted FIG. 1, except that system 20 also includes network apparatus 29, which functions as a traditional conference server as understood in the art. According to this exemplary embodiment of the present invention, conferencing apparatus 15 is connected to the dedicated conference server, but still operates in a similar manner as described with reference to system 10 in FIG. 1.

As discussed above, the control part 15b determines when the online conference starts (or is about ready to start) by monitoring data transmitted by the plurality of terminals to the network and determining, based on the transmitted data, when at least one of the terminals 12-1 through 12-4 begins transmitting desktop image data to the network. This is the same desktop image data that is or will be shared with the other terminals in the online conference. Similarly, the control part determines when the online conference ends by monitoring the data transmitted by the plurality of terminals to the network and determining, based on the transmitted data, when at least one of the terminals 12-1 through 12-4 stops transmitting the desktop image data to the network.

If the conferencing apparatus 15 is functioning as a traditional conference server, then the desktop image data that will be shared in an online conference will first be transmitted directly from one of the terminals to the conferencing apparatus 15 itself, via the network 11. Thus, the conferencing apparatus will be able to determine when the online conference starts and ends based on these received transmissions of desktop image data. Alternatively, if the conferencing apparatus 15 is not functioning as a traditional conference server, the conferencing apparatus 15 may be able to determine when an online conference starts and ends by monitoring data transmitted by the plurality of terminals to the network and determining, based on the transmitted data, whether desktop image data is being transmitted by the terminals to the network 11.

Further aspects of the conferencing apparatus 15 according to this disclosure will now be discussed.

As previously stated, the control part 15b of the conferencing apparatus 15 transmits the desktop recording (of the desktop image data shared between the plurality of terminals 12-1 through 12-4 in the online conference) to the data repository 14. According to another aspect of this disclosure, after the control part 15b has transmitted the desktop recording to the data repository 14, the control part may receive an update command from one of the plurality of terminals with instructions for the control part to update the desktop recording now stored in the data repository 14. The update command may be transmitted from one of the terminals 12-1 through 12-4 that corresponds to the “leader” or “presenter” of the online conference, for example. (The update command may also be transmitted in response to an update request transmitted by the conferencing apparatus to one of the plurality of terminals, although such a step is entirely optional).

The update request may include a request to alter some aspect of the desktop recording that has been transmitted and stored in the data repository. For example, the update request may inquire whether the user wishes to delete the entire desktop recording, delete any portion of the desktop recording, change the content of the desktop recording, or change the storage location in the data repository of the desktop recording. Many other possible changes to the desktop recording are possible (such as changing the security/access rights to the desktop recording).

Thereafter, the control part 15b updates the desktop recording based on the update command. For example, the control part deletes the entire desktop recording, deletes a portion of the desktop recording, or changes the storage location in the data repository of the desktop recording, based on the update command.

Thus, according to this aspect of this disclosure, a participant in an online conference, such as the presenter of the online conference, has the ability to review a desktop recording after the desktop recording has been stored in the data repository. If the user decides that it is not necessary for the desktop recording of the online conference to be saved for future use, the user may easily instruct the conferencing apparatus to delete the desktop recording. If the user decides that they wish to alter the content of the desktop recording, the user may easily instruct the conferencing apparatus to effect the appropriate alterations. If the user decides that the storage location of the desktop recording in the data repository is not satisfactory, the user may easily instruct the conferencing apparatus to store the desktop recording in another storage location in the data repository.

According to another aspect of this disclosure, the update command may include instructions for the conferencing apparatus to change the specified recipients of the report email, the text content of a report email, or the URL link content of a report and email, for example.

The conferencing apparatus may then prepare a report email based on the update command, and transmit the report email to users of the plurality of terminals, the report email including acquisition information for acquiring the desktop recording from the data repository.

The acquisition information included in the report email may include a folder link, Universal Resource Locator (URL) or some other information that may be used to identify the location in the document repository 14 where the desktop recording is stored. In particular, the acquisition information may include a data repository address link; when the data repository address link is accessed by the terminal (after a user of the terminal selects the address link in the report email, for example), this automatically causes the desktop recording to be downloaded from the data repository to the terminal, without necessitating any further action on the part of the user of the terminal.

The report email may be transmitted from the conferencing apparatus 15 to users of the plurality of terminals 12-1 through 12-4 via a mail server (not shown) connected to the network 11, as is well known in the art.

Thus, according to this aspect of this disclosure, a report email transmitted by the conferencing apparatus 15 provides participants in an online conference with a convenient and user-friendly way to retrieve a desktop recording of desktop image data shared in an online conference. Moreover, a participant in the online conference, such as the presenter of the online conference, has the ability to fashion the report email so that the report email is only transmitted to specified recipients, only contains certain text content, only contains particular URL links, and so forth.

According to another aspect of this disclosure, the control part 15b of the conferencing apparatus 15 may also have the ability to create conference participation information identifying the users of the plurality of terminals, based on user identification information transmitted by the plurality of terminals 12-1 through 12-4 to the network 11.

If the conferencing apparatus 15 is functioning as a traditional conference server, as described above, then the plurality of terminals will enter into the online conference by first transmitting user identification information directly to the conferencing apparatus 15 itself, via the network 11. Thus, the control part 15b of the conferencing apparatus 15 will be able to analyze the received transmissions of user identification information, in order to create conference participation information identifying the users of the plurality of terminals. (Alternatively, if the conferencing apparatus 15 is not functioning as a traditional conference server, the conferencing apparatus 15 may be able to create conference participation information by analyzing user identification information transmitted by the terminals to the network 11).

User identification information may include information such as usernames, email addresses, passwords, screen names, telephone numbers, facsimile numbers, and biometric information (fingerprints, palm prints, voice or speech, retinas or irises, facial expressions or features, signature, etc.).

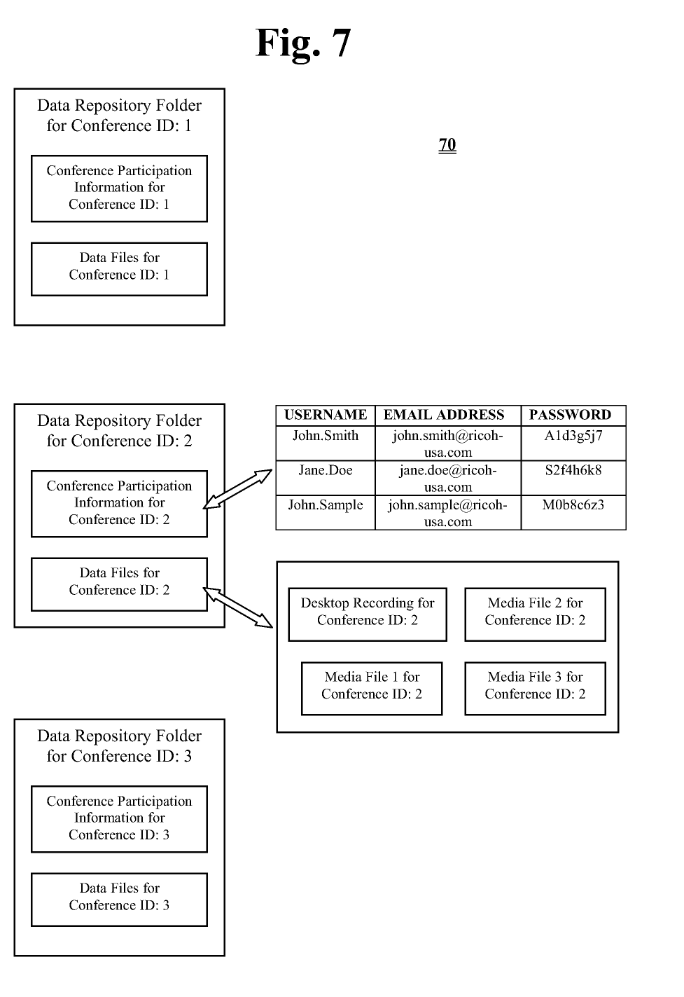

FIG. 6 shows an example of conference participation information identifying users of a plurality of terminals, such as terminals 12-1 through 12-4. The conference participation information (which is depicted within a conference participation information table) includes a plurality of usernames (representing the users of the plurality of terminals that may be participants in an online conference), as well as the respective e-mail addresses corresponding to the usernames and the respective passwords corresponding to the usernames. For example, for the username John.Smith, the corresponding email address is “john.smith@ricoh-usa.com” and the corresponding password is A1d3g5j7, and for the username Jane.Doe, the corresponding email address “jane.doe@ricoh-usa.com” the corresponding password is S2f4h6k8.

It should be apparent that the conference participation information contained within the conference participation information table is not limited to that shown in FIG. 6, which merely presents an example. In particular, while the conference participation information shown FIG. 6 includes usernames, e-mail addresses, and passwords, the conference participation information can instead (or in addition) store various other information that may be used to identify a user of a terminal that may be a participant in an online conference. For example, the conference participation information can include a plurality of names and/or screen names, telephone numbers, facsimile numbers, etc. The conference participation information may include biometric information (such as fingerprints, palm prints, voice or speech, retinas or irises, facial expressions or features, signature, etc).

Once the control part 15b of the conferencing apparatus has created the conference participation information, it is then possible for the control part 15b to prepare the report email (including acquisition information for acquiring the desktop recording from the data repository 14) and simply transmit the report email to the users of the plurality of terminals listed in the conference participation information. In this way, it can be ensured that all participants in the online conference receive the report email that includes the acquisition information. Of course, the conferencing apparatus 15 may also be configured to transmit the report email to additional users (such as intended conference participants that were unable to log into/participate in the online conference), as necessary.

Furthermore, once the conferencing apparatus 15 transmits the desktop recording to the data repository 14, the conferencing apparatus may also transmit the corresponding conference participation information to the data repository. In this way, the desktop recording may be stored in the data repository 14 in association with the corresponding conference participation information.

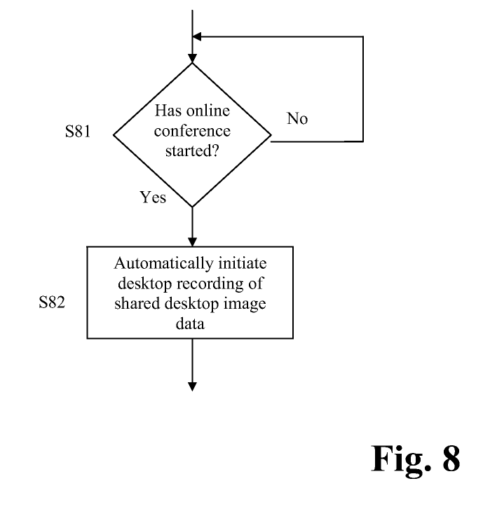

FIG. 7 shows an example of the storage contents 70 of the data repository 14, and illustrates the hierarchical structure in which the storage contents 70 are stored in the data repository 14. In particular, FIG. 7 depicts how a desktop recording of an online conference may be stored in the data repository 14 in association with the conference participation information corresponding to that online conference.

Storage contents 70 include a plurality of data repository folders, each data repository folder corresponding to a different online conference (each identified by a unique Conference ID). For example, there is a first folder that is the data repository folder for Conference ID: 1, a second folder that is the data repository folder for Conference ID: 2, and a third folder that is the data repository folder for Conference ID: 3.

Stored within each data repository folder is the conference participation information and the data files corresponding to that particular conference. For example, In the data repository folder for Conference ID: 2, there is stored the conference participation information for Conference ID: 2 and the data files for Conference ID: 2. The conference participation information is substantially similar to that described and depicted in FIG. 6, and includes information identifying users of terminals that are participants in that online conference (in this case, Conference ID: 2). The data files include any data files that may be related to that online conference (i.e. Conference ID: 2). At least one of the data files is the desktop recording of the shared desktop image data of that online conference.

Various other media files (video, audio, text, notes, application files etc.) related to that online conference—including content that may have been shared in the online conference—may also be stored as data files for each online conference. (Thus, it should be understood that the control part 15b of the conferencing apparatus 15 also has the ability to transmit all types of conference data shared between the plurality of terminals in the online conference to the data repository 14, and consequently that the acquisition information in the report email transmitted to the plurality of terminals may be used to acquire all types of conference data from the data repository 14).

Therefore, FIG. 7 demonstrates that a desktop recording of an online conference may be stored in the data repository in association with the conference participation information corresponding to that online conference. While the depiction in FIG. 7 illustrates the detail of the conference participation information and data files stored in the data repository folder for Conference ID: 2, it should be understood that similar conference participation information and data files are stored in the other data repository folders for Conference ID: 1 and Conference ID: 3.

It should be apparent that the storage contents contained within the data repository 14 are not limited to that shown in FIG. 7, which merely presents an example. For example, data repository 14 may store further information regarding each conference. Such information may include (but is not limited to) a conference subject/title, a scheduled conference start and stop time, an indicator as to whether a conference is active or not, leader information identifying a leader of the conference, domain information indicating whether each participant of the online conference is internal or external to an enterprise organization, URLs identifying the storage location in the data repository 14 of each of the data files and/or data repository folders, and access control indicators indicating the access rights (internal or external to an enterprise organization) of each of the data files and/or data repository folders.

While the examples shown in FIGS. 1-2 include one document repository 14, one conferencing apparatus 15 and four terminals 12-1 through 12-4, it should be appreciated that such numbers of repositories, apparatuses and terminals are arbitrary and are selected as an example in order to facilitate discussion, and that the subject matter of this disclosure can be implemented in a system including one or more repositories, apparatuses and terminals. Further, it is noted that a conferencing apparatus, terminal and/or document repository can be included in one integrated device (or of course can be separate devices). Other devices, such as scanners, printers and multi-function devices (MFDs) may also be connected to the network 11, as is well known in the art.

Each of the terminals 12-1 through 12-4 can be any computing device, including but not limited to a personal, notebook or workstation computer, a kiosk, a PDA (personal digital assistant), a MFD (multi-function device), a server, a mobile phone or handset, another information terminal, etc., that can communicate through the network 11 with other devices.

While only four terminals 12-1 through 12-4 are depicted in each of FIGS. 1-2, it should be understood that systems 10-20 can include any number of terminals (which can have similar or different configurations) connected to the network 11. Further, while this discussion has referred to the four terminals 12-1 through 12-4 as participating in an online conference, it should be understood that any plural number of terminals connected to the network 11 may be participating in an online conference.

The conferencing apparatus 15 can be any computing device, including but not limited to a personal, notebook or workstation computer, a kiosk, a PDA (personal digital assistant), a MFD, a server, a mobile phone or handset, another information terminal, etc., that can communicate through the network 11 with other devices.

The data repository 14 can comprise one or more structural or functional parts that have or support a storage function. For example, the data repository 14 can be, or can be a component of, a source of electronic data, such as a web server, a backend server connected to a web server, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

The network 11 can include one or more of a secure intranet or extranet local area network, a wide area network, any type of network that allows secure access, etc., or a combination thereof. Further, other secure communications links (such as a virtual private network, a wireless link, etc.) may be used as well in the network 11. In addition, the network 1 preferably uses TCP/IP (Transmission Control Protocol/Internet Protocol), but other protocols can also be used. How devices can connect to and communicate over the network 11 is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

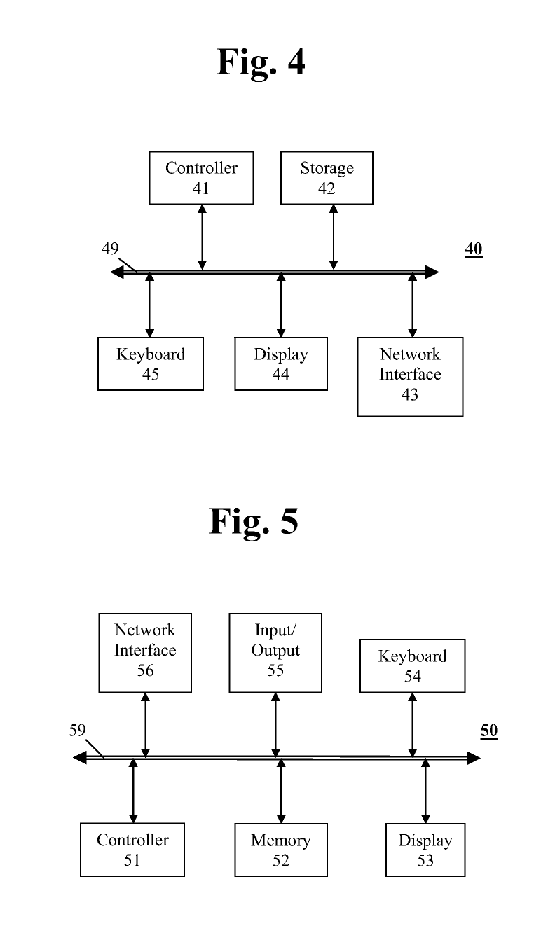

FIG. 4 shows an exemplary constitution of a conferencing apparatus 40 (for example, as a server) that can be configured through software to provide conferencing apparatus 15. As shown in FIG. 4, the conferencing apparatus 40 includes a controller (or central processing unit) 41 that communicates with a number of other components, including memory or storage part 42, network interface 43, display 44 and keyboard 45, by way of a system bus 49.

The conferencing apparatus 40 may be a special-purpose device (such as including one or more application specific integrated circuits or an appropriate network of conventional component circuits) or it may be software-configured on a conventional personal computer or computer workstation with sufficient memory, processing and communication capabilities to operate as a conferencing apparatus and/or server, as will be appreciated to those skilled in the relevant arts.

In conferencing apparatus 40, the controller 41 executes program code instructions that control conferencing apparatus operations. The controller 41, memory/storage 42, network interface 43, display 44 and keyboard 45 are conventional, and therefore in order to avoid occluding the inventive aspects of this disclosure, such conventional aspects will not be discussed in detail herein.

The conferencing apparatus 40 includes the network interface 43 for communications through a network, such as communications through the network 11 with the terminals 12-1 through 12-4 and data repository 14 in FIGS. 1-2, and network apparatus 29 in FIG. 2. However, it should be appreciated that the subject matter of this disclosure is not limited to such configuration. For example, the conferencing apparatus may communicate with the terminals 12-1 through 12-4, data repository 14 and network apparatus 29 through direct connections and/or through a network to which some components are not connected. As another example, the conferencing apparatus need not be provided by a server that services terminals, but rather may communicate with the terminals on a peer basis, or in another fashion.

As mentioned above, conferencing apparatus 15 is not limited to a server or computer, but can be manifested in any of various devices that can be configured to communicate over a network and/or the Internet.

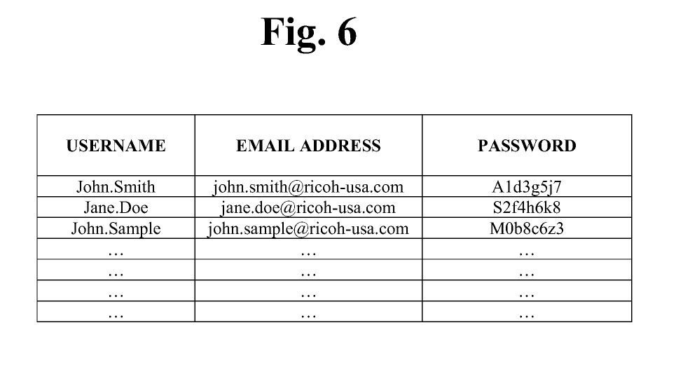

An example of a configuration of one of the plurality of terminals 12-1 through 12-4 (for example, as a computer) is shown schematically in FIG. 5. In FIG. 5, computer 50 includes a controller (or central processing unit) 51 that communicates with a number of other components, including memory 52, display 53, keyboard (and/or keypad) 54, other input/output (such as mouse, touchpad, stylus, microphone and/or speaker with voice/speech interface and/or recognition software, etc.) 55, and network interface 56, by way of internal bus 59.

The memory 52 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 56 provides a connection (for example, by way of an Ethernet connection or other network connection which supports any desired network protocol such as, but not limited to TCP/IP, IPX, IPX/SPX, or NetBEUI) to network 11.

A user interface is provided and is configured through software natively or received through a network connection, to allow the user to access electronic data or content on the terminal and/or via the network, interact with network-connected devices and services (such as data repository 14 or conferencing apparatus 15), enjoy other software-driven functionalities, etc. For example, a browser (such as Internet Explorer™, Netscape Navigator™, a proprietary browser, etc.) may be provided on the terminal so that a user of the terminal can use browsing operations to communicate with the data repository 14 and/or conferencing apparatus 15, and access other data or content.

Additional aspects or components of the computer 50 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

As mentioned above, each of the terminals 12-1 through 12-4 is not limited to a personal computer, but can be manifested in a form of any of various devices that can be configured to communicate over a network and/or the Internet.

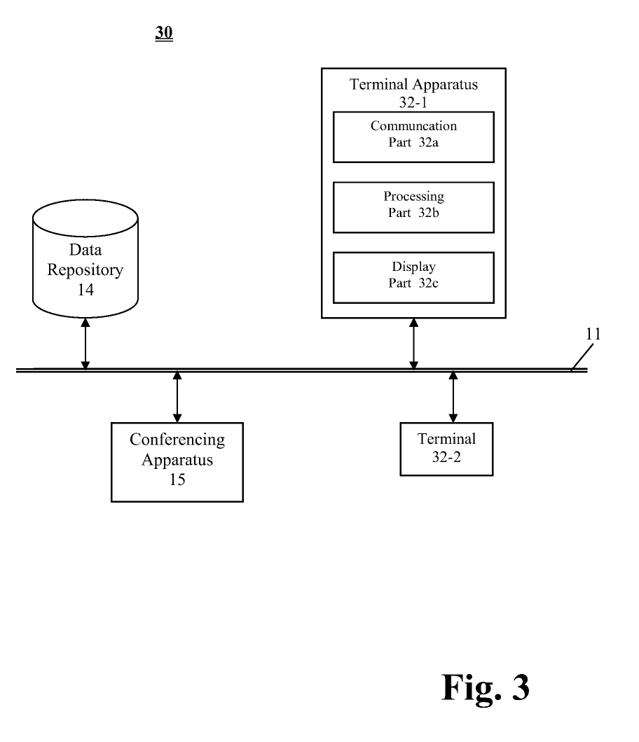

FIG. 3 shows a block diagram of a system, according to another exemplary embodiment of this disclosure. FIG. 3 includes a data repository 14, conferencing apparatus 15 and terminal apparatus 32-1 and terminal 32-2 connected to a network 11. Data repository 14, conferencing apparatus 15 and network 11 are identical to those of FIGS. 1-2.

Terminal apparatus 32-1 includes a communication part 32a, a processing part 32b and a display part 32c.

The communication part 32a of terminal apparatus 32-1 is configured to communicate with the terminal 32-2 and the conferencing apparatus 15 via network 11. The communication part is also configured to transmit desktop image data to the conferencing apparatus 15. This is the desktop image data that is being shared with the terminal 32-2 in an online conference. This desktop image data is also recorded by the conferencing apparatus in a desktop recording, which is stored in data repository 14.

The display part 32c of terminal apparatus 32-1 is configured to display an image based on desktop image data.

The processing part 32b of terminal apparatus 32-1 is configured to determine whether an update command instructing the conferencing apparatus 15 to update the desktop recording stored in the data repository 14 is required. In particular, the processing part may determine whether the update command is required based on user input. For example, a user of the terminal apparatus 32-1 may indicate that they wish to update the desktop recording, by entering input commands into a software application (such as a browser or conferencing application) operating on the terminal apparatus.

The processing part 32b is also configured to receive an update request to update the desktop recording stored in the data repository, from the conferencing apparatus 15. In response, processing part 32b is configured to transmit to the conferencing apparatus 15 the update command to update the desktop recording, based on input by a user of the terminal apparatus as discussed above. The receipt by the terminal apparatus 32-1 of an update request transmitted by the conferencing apparatus, before the terminal apparatus transmits the update command, is entirely optional.

The update command may include instructions for the conferencing apparatus 15 to change the content of the desktop recording stored in the data repository, or the storage location in the data repository of the desktop command. The conferencing apparatus updates the desktop recording stored at the document repository, based on the update command.

Furthermore, the terminal apparatus 32-1 may receive a report email from the conferencing apparatus 15, the report email including acquisition information for acquiring the desktop recording from the data repository. (Note that the update command may include instructions for the conferencing apparatus to change the specified recipients of the report email, the text content of the report email or the URL link content of the report email, and thus the report email may be prepared by the conferencing apparatus based on the update command).

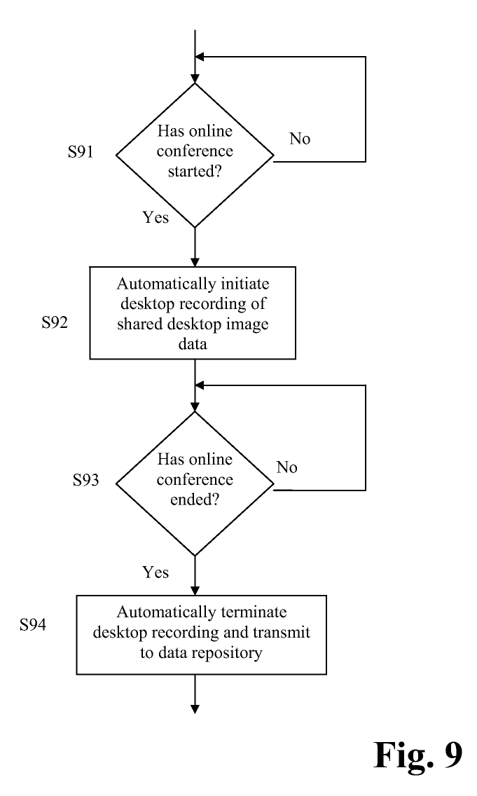

Turning now to FIG. 8, a flow chart is shown illustrating an example of a workflow on a conferencing apparatus side (such as the conferencing apparatus 15).

Firstly, the conferencing apparatus determines when an online conference between a plurality of terminals connected to a network starts, by monitoring data transmitted by the plurality of terminals to the network and determining, based on the transmitted data, when at least one of the plurality of terminals begins transmitting desktop image data (to be shared with the plurality of terminals) to the network (s81). If it is determined that the online conference has started or is ready to start (S81, yes), the conferencing apparatus automatically initiates a desktop recording of desktop image data shared between the plurality of terminals in the online conference (s82). If it is determined that the online conference has not started or is not ready to start (s81, no), then the conferencing apparatus continues to determine when an online conference between the plurality of terminals starts (s81).

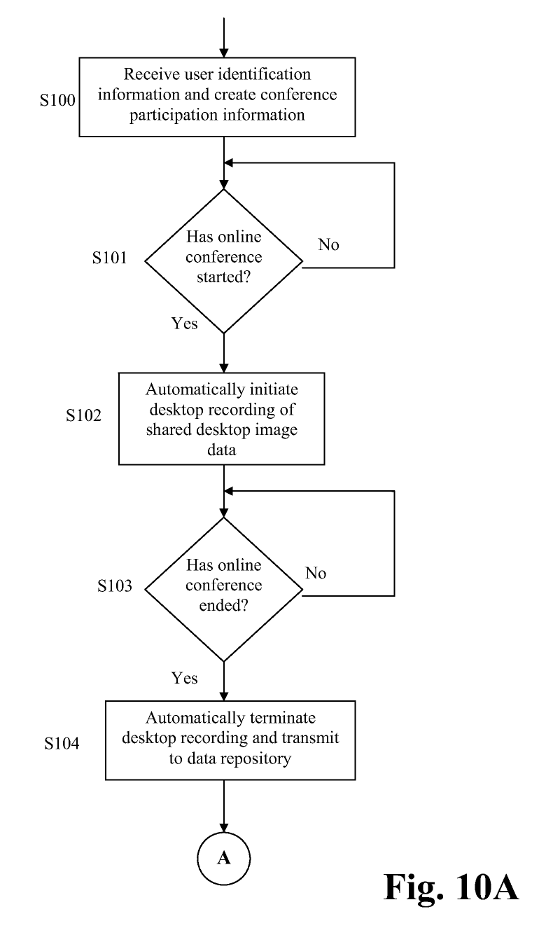

In FIG. 9, a flow chart is shown illustrating a more detailed example of a workflow on a conferencing apparatus side (such as the conferencing apparatus 15).

Steps (s91) and (s92) are substantially similar to steps (s81) and (s82) of FIG. 8.

After the conferencing apparatus has automatically initiated the desktop recording of shared desktop image data (s92), the conferencing apparatus determines when the online conference that has already started between the plurality of terminals ends (s893). The conferencing apparatus determines when the online conference ends by monitoring data transmitted by the plurality of terminals to the network and determining, based on the transmitted data, when at least one of the plurality of terminals stops transmitting desktop image data to the network. (This need not be the same terminal that was used to determine when the online conference started in step (s91). That is, a first terminal may have begun transmitting desktop image data at the start of the online conference, but at some time in the online conference a second terminal may also have begun transmitting desktop image data. Thus, it is possible that the conferencing apparatus may alternatively determine that the online conference has ended, by determining that all of the plurality of terminals are not transmitting desktop image data to the network).

If it is determined that the online conference that has already started has ended (S93, yes), then the conferencing apparatus automatically terminates the desktop recording and transmits the desktop recording to a data repository connected to the network (s94). If it is determined that the online conference that has already started has not ended (s93, no), then the conferencing apparatus continues to determine when an online conference between the plurality of terminals ends (s93).

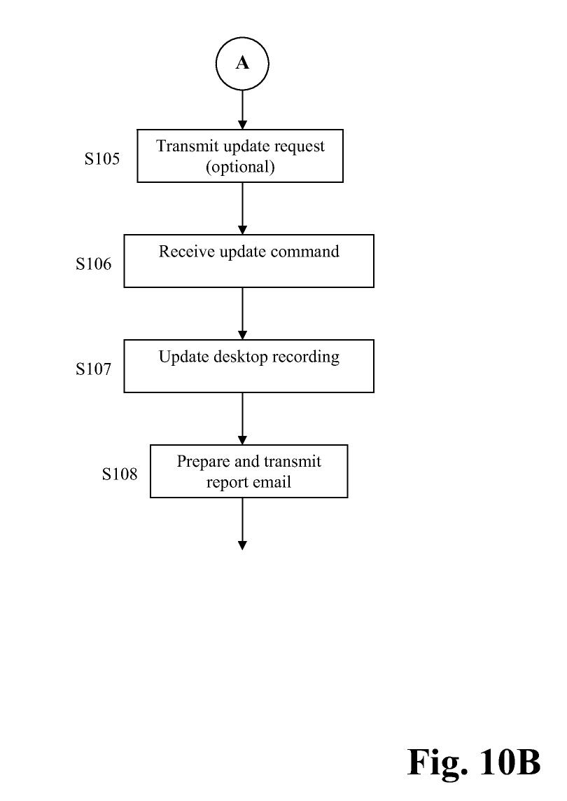

In FIGS. 10A and 10B, a flow chart is shown illustrating a more detailed example of a workflow on a conferencing apparatus side (such as the conferencing apparatus 15).

Firstly, the conferencing apparatus receives user identification information transmitted by a plurality of terminals connected to the network, and creates conference participation information identifying users of the plurality of terminals, based on the user identification information (s100).

Steps (s101) through (s104) are substantially similar to steps (s91) through (s94) of FIG. 9.

After the conferencing apparatus has transmitted the desktop recording to the data repository connected to the network (s104), the conferencing apparatus transmits an update request to one of the plurality of terminals (s105), although this step is optional. The conferencing apparatus then receives an update command instructing the conferencing apparatus to update the desktop recording (s106). The update command may include instructions for the conferencing apparatus to change the content of the desktop recording stored in the data repository, or the storage location in the data repository of the desktop command. The conferencing apparatus then updates the desktop recording stored at the document repository, based on the received update command (s107).

Finally, the conferencing apparatus prepares and transmits a report email to users of the plurality of terminals (which may be the users identified in the conference participation information created in S100), the report email including acquisition information for acquiring the desktop recording from the data repository (s108). Note that the update command may include instructions for the conferencing apparatus to change the specified recipients of the report email, the text content of the report email, or the URL link content of the report and email, and thus the report email may be prepared based on the update command.

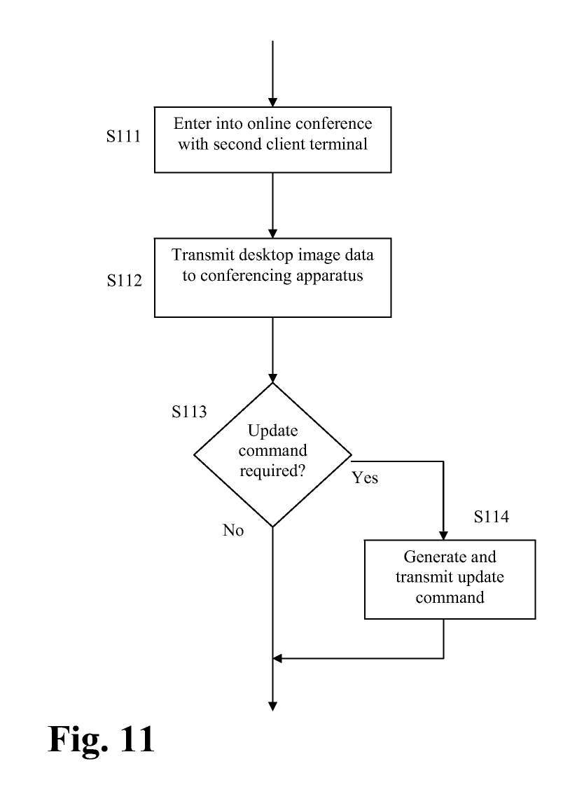

Turning now to FIG. 11, a flow chart illustrating an example of a workflow on a terminal apparatus side (such as terminal apparatus 32-1 shown in FIG. 3) is presented.

Firstly, the terminal apparatus enters into an online conference with another terminal connected to a network (s111). This step of entering into online conference may entail transmitting user identification information to the network.

The terminal apparatus then transmits desktop image data to a conferencing apparatus (s112). This desktop image data is shared with the other terminal in the online conference, and is automatically recorded by the conferencing apparatus in a desktop recording, which the conferencing apparatus may store in a data repository.

Then, the terminal apparatus determines whether an update command instructing the conferencing apparatus to update the desktop recording is required, based on user input (s113). If it is determined that an update command is required (s113, Yes), then the terminal apparatus generates the update command and transmits the update command to the conferencing apparatus (s114). If it is determined that an update command is not required (s113, No), then the terminal apparatus does not generate or transmit the update command.

The update command may include instructions for the conferencing apparatus to change the content of the desktop recording stored in the data repository, or the storage location in the data repository of the desktop command. (Note that the update command may also include instructions for the conferencing apparatus to change the specified recipients of a report email, the text content of a report email, or the URL link content of a report email). The conferencing apparatus updates the desktop recording stored at the document repository, based on the update command.

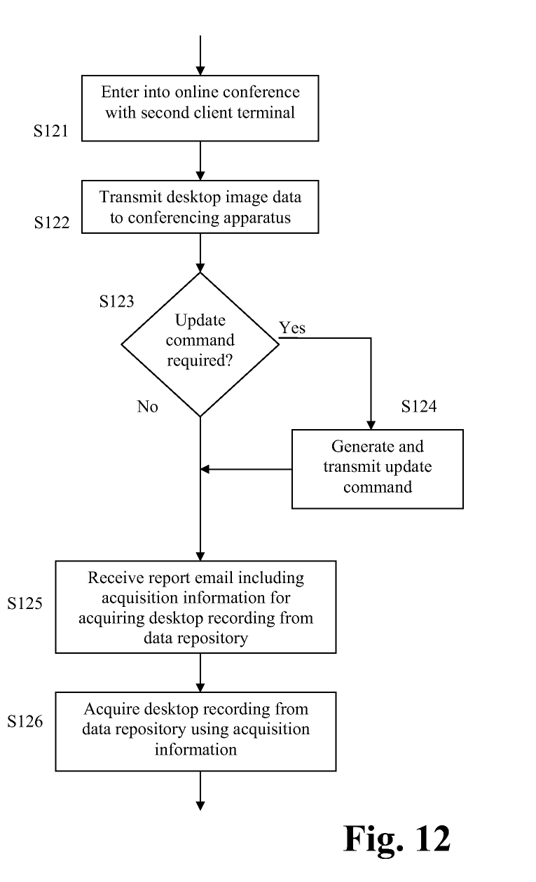

In FIG. 12, a flow chart is shown illustrating a more detailed example of a workflow on a terminal apparatus side (such as terminal apparatus 32-1 shown in FIG. 3).

Steps (s121) through (s124) are substantially similar to steps (sill) through (s114) of FIG. 11.

Thereafter, the terminal apparatus receives a report email from the conferencing apparatus (s125), the report email including acquisition information for acquiring the desktop recording of the shared desktop image data from the data repository. (Note that the update command transmitted by the terminal apparatus to the conferencing apparatus may include instructions for the conferencing apparatus to change the specified recipients of the report email, the text content of the report email or the URL link content of the report email, and thus the report email may be prepared based on the update command).

After the terminal apparatus receives the report email (s125), the terminal apparatus acquires the desktop recording from the data repository, using the acquisition information included in the report email (s126).

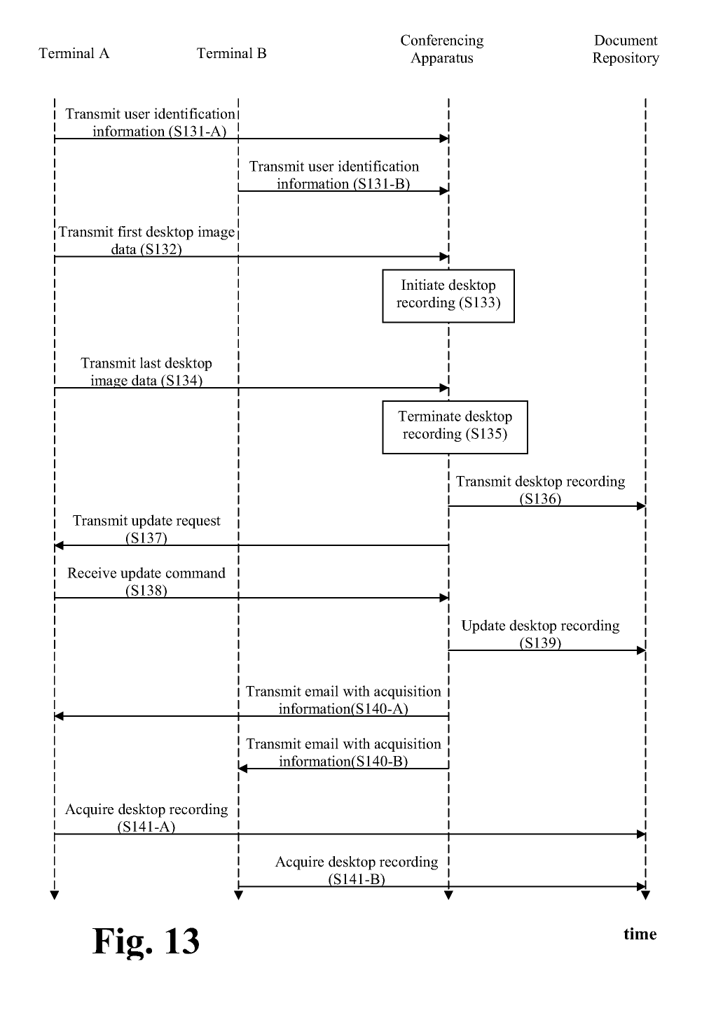

Turning now to FIG. 13, a schematic view of an example of data flow in an exemplary embodiment is presented.

Terminal A transmits user identification information to a conferencing apparatus (s131-A). Thereafter, terminal B transmits user identification information to the conference apparatus (s131-B).

Then, terminal A begins transmitting desktop image data to be shared sharing in an online conference to the conferencing apparatus (s132). After the conferencing apparatus determines that the online conference has started or is ready to start, by monitoring data transmitted by the terminals to the network and determining based on the transmitted data that terminal A has begun transmitting the desktop image data in (s132), the conferencing apparatus automatically initiates a desktop recording of the desktop image data shared in the online conference (s133).

Then terminal A transmits the last desktop image data shared in the online conference to the conferencing apparatus (s134). After the conferencing apparatus determines that the online conference has ended, by monitoring the data transmitted by the terminals to the network and determining based on the transmitted data that terminal A has stopped transmitting the desktop image data in (s134), the conferencing apparatus automatically terminates the desktop recording (s135) and transmits the desktop recording to a data repository (s136).

Then, the conferencing apparatus transmits an update request to terminal A (s137), although this step is optional. Terminal A transmits an update command to the conferencing apparatus, based on input by a user of terminal A (s138). The update command may include instructions for the conferencing apparatus to change the content of the desktop recording stored in the data repository, or the storage location in the data repository of the desktop command. The conferencing apparatus updates the desktop recording stored at the document repository, based on the update command received from terminal A (s139).

Thereafter, the conferencing apparatus prepares and transmits a report email to a user of the terminal A, the report email including acquisition information for acquiring the desktop recording from the data repository (s140-A). The conferencing apparatus also prepares and transmits a similar report email to a user of the terminal B (s140-B). Note that the update command transmitted in step (s138) may include instructions for the conferencing apparatus to change the specified recipients of the report email, the text content of the report email or the URL link content of the report email, and thus the report email may be prepared based on the update command.

Finally, terminal A connects to the data repository, and uses the acquisition information included in the report email to acquire the desktop recording of the shared desktop image data from the data repository (s141-A). Similarly, terminal B connects to the data repository, and uses the acquisition information included in the report email to acquire the desktop recording of the shared desktop image data from the data repository (s141-B).

The above-mentioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

1. A conferencing apparatus configured to communicate over a network, said conferencing apparatus comprising:
a communication part configured to communicate with a data repository connected to the conferencing apparatus through the network; and
a control part configured to
(a) determine when an online conference between a plurality of terminals connected to the network starts, by monitoring data transmitted by the plurality of terminals to the network and determining based on the transmitted data when at least one of said plurality of terminals begins transmitting desktop image data to be shared with said plurality of terminals to the network, and
(b) automatically initiate, when it is determined based on (a) that the online conference has started or is ready to start, a desktop recording of the desktop image data shared between the plurality of terminals.

2. The conferencing apparatus of claim 1, wherein the control part determines when the online conference ends, by monitoring the data transmitted by the plurality of terminals to the network and determining based on the transmitted data when at least one of said plurality of terminals stops transmitting the desktop image data to the network, and
wherein the control part automatically terminates the desktop recording and transmits the desktop recording to the data repository, when it is determined that the online conference has ended.

3. The conferencing apparatus of claim 2, wherein after the desktop recording has been transmitted to the data repository, the control part prepares and transmits a report email to users of the plurality of terminals, said report email including acquisition information for acquiring the desktop recording from the data repository.

4. The conferencing apparatus of claim 2, wherein the control part creates conference participation information identifying users of the plurality of terminals, based on user identification information transmitted by the plurality of terminals to the network.

5. The conferencing apparatus of claim 4, wherein after the desktop recording has been transmitted to the data repository, the control part prepares and transmits a report email to said users of the plurality of terminals listed in the conference participation information, said report email including acquisition information for acquiring the desktop recording from the data repository.

6. The conferencing apparatus of claim 4, wherein the desktop recording is stored in the data repository in association with the conference participation information.

7. The conferencing apparatus of claim 3, wherein the control part transmits all conference data shared between the plurality of terminals in the online conference to the data repository, and
wherein the acquisition information in the report email transmitted to the plurality of terminals may be used to acquire the conference data from the data repository.

8. The conferencing apparatus of claim 1, wherein an image based on the desktop image data is outputted to a display part of at least one of said plurality of terminals.

9. A terminal apparatus configured to perform online conferencing over a network, said terminal apparatus comprising:
a communication part configured to communicate with a conferencing apparatus via the network, and transmit desktop image data to the conferencing apparatus to be shared with said another terminal in an online conference and to be automatically recorded by the conferencing apparatus in a desktop recording; and
a processing part configured to determine whether an update command instructing the conferencing apparatus to update the desktop recording is required, based on user input, and when it is determined that the update command is required, generate the update command and cause the communication part to transmit the update command to the conferencing apparatus.

10. The terminal apparatus of claim 9, wherein the conferencing apparatus stores the desktop recording in a data repository, and
wherein the conferencing apparatus updates the desktop recording stored in the data repository, based on the update command.

11. The terminal apparatus of claim 10, wherein the update command includes instructions for the conferencing apparatus to change the content of the desktop recording stored in the data repository.

12. The terminal apparatus of claim 10, wherein the update command includes instructions for the conferencing apparatus to change any one of: specified recipients of a report email, text content of the report email, and URL link content of the report email, and
wherein after the terminal apparatus transmits the update command, the terminal apparatus and said another terminal receive from the conferencing apparatus the report email, said report email including acquisition information for acquiring the desktop recording from the data repository.

13. A computer readable medium tangibly embodying a series of instructions which, when executed by a conferencing apparatus configured to communicate over a network, causes the conferencing apparatus to perform a method comprising the steps of:
(a) determining when an online conference between a plurality of terminals connected to the network starts, by monitoring data transmitted by the plurality of terminals to the network and determining based on the transmitted data when at least one of said plurality of terminals begins transmitting desktop image data to be shared with said plurality of terminals to the network; and
(b) automatically initiating, when it is determined based on (a) that the online conference has started or is ready to start, a desktop recording of the desktop image data shared between the plurality of terminals.

14. The computer readable medium of claim 13, wherein the method comprises the further steps of:
(c) determining when the online conference ends, by monitoring the data transmitted by the plurality of terminals to the network and determining based on the transmitted data when at least one of said plurality of terminals stops transmitting the desktop image data to the network; and
(d) automatically terminating the desktop recording and transmitting the desktop recording to a data repository connected to the network, when it is determined based on (c) that the online conference has ended.

15. The computer readable medium of claim 14, wherein the conferencing apparatus prepares and transmits a report email to the plurality of terminals, said report email including acquisition information for acquiring the desktop recording from the data repository.

16. The computer readable medium of claim 15, wherein the acquisition information included in the report email transmitted to said users of the plurality of terminals includes a data repository address link which, when accessed by one of the plurality of terminals, causes the desktop recording to he downloaded from the data repository to said one of the plurality of terminals.

17. The computer readable medium of claim 14, wherein the conferencing apparatus receives an update command from said first one of the plurality of terminals, and updates the desktop recording stored in the data repository, based on the update command.

18. The computer readable medium of claim 17, wherein the update command includes instructions for the conferencing apparatus to change any one of: the content of the desktop recording stored in the data repository, and the storage location in the data repository of the desktop recording.

19. The computer readable medium of claim 17, wherein the update command includes instructions for the conferencing apparatus to change any one of: specified recipients of a report email, text content of the report email, and URL link content of the report email.

20. The computer readable medium of claim 19, wherein after the conference apparatus receives the update command, the conferencing apparatus prepares and transmits the report email to the plurality of terminals, said report email including acquisition information for acquiring the desktop recording from the data repository.

21. An application program product tangibly embodying a series of instructions which, when executed by a terminal apparatus configured to perform online conferencing over a network, causes the terminal apparatus to perform a method comprising the steps of:
entering into an online conference with another terminal connected to the network;
transmitting desktop image data to a conferencing apparatus connected to the network, to be shared with said another terminal in an online conference and to be automatically recorded by the conferencing apparatus in a desktop recording;
determining whether an update command instructing the conference apparatus to update the desktop recording is required, based on user input; and
generating the update command and transmitting the update command to the conferencing apparatus, when it is determined that the update command is required.

22. The application program product of claim 21, wherein the conferencing apparatus stores the desktop recording in a data repository, and
wherein the conferencing apparatus updates the desktop recording stored in the data repository, based on the update command.

23. The application program product of claim 22, wherein the update command includes instructions for the conferencing apparatus to change the content of the desktop recording stored in the data repository.

24. A conferencing system comprising:
a conferencing apparatus configured to communicate over a network;
a plurality of terminals connected to the network; and
a data repository connected to the network,
wherein the conferencing apparatus:
(a) determines when an online conference between the plurality of terminals starts, by monitoring data transmitted by the plurality of terminals to the network and determining based on the transmitted data when at least one of said plurality of terminals begins transmitting desktop image data to be shared with said plurality of terminals to the network, and
(b) automatically initiates, when it is determined based on (a) that the online conference has started or is ready to start, a desktop recording of the desktop image data shared between the plurality of terminals.

25. The system of claim 24, wherein the conferencing apparatus determines when the online conference ends, by monitoring the data transmitted by the plurality of terminals to the network and determining based on the transmitted data when at least one of said plurality of terminals stops transmitting the desktop image data to the network, and
wherein the conferencing apparatus automatically terminates the desktop recording and transmits the desktop recording to the data repository, when it is determined that the online conference has ended.

26. The system of claim 25, wherein after the desktop recording has been transmitted to the data repository, the conferencing apparatus prepares and transmits a report email to users of the plurality of terminals, said report email including acquisition information for acquiring the desktop recording from the data repository.

27. The system of claim 25, wherein the conferencing apparatus creates conference participation information identifying users of the plurality of terminals, based on user identification information transmitted by the plurality of terminals to the network.

28. The system of claim 27, wherein after the desktop recording has been transmitted to the data repository, the conferencing apparatus prepares and transmits a report email to said users of the plurality of terminals listed in the conference participation information, said report email including acquisition information for acquiring the desktop recording from the data repository.

29. The system of claim 27, wherein the desktop recording is stored in the data repository in association with the conference participation information.

30. The system of claim 25, wherein the conferencing apparatus transmits all conference data shared between the plurality of terminals in the online conference to the data repository, and
wherein the acquisition information in the report email transmitted to the plurality of terminals may be used to acquire the conference data from the data repository.
